(19) United States
(12) Patent Application Publication
(10) Pub. No.: US 2003/0214067 A1
(43) Pub. Date: Nov. 20, 2003

(54) Twin screw extruders for processing wood fiber and process for same

(76) Inventors: David E Murdock, Dublin, OH (US); Dale K Snead, Yardley, PA (US); Darrell S Dardenne, St Agustine, FL (US); Ian W Mills, Westerly, RI (US)

Correspondence Address: Daniel Reitenbach, Crompton Corporation, Benson Road, Middlebury, CT, 06749, US

(21) Appl. No.: 10/257,234

(22) PCT Filed: Apr. 30, 2001
(86) PCT No.: PCT/US01/13745

(51) Int. Cl. B29C 47/76

(52) U.S. Cl. 264/102; 264/349; 425/208; 425/209; 425/377; 425/812

(57) ABSTRACT

The invention is extrusion equipment and a process. The extrusion equipment links two extruders (11, 15) together. The first extruder (11) is, desirably, a counter-rotating twin screw extruder. The first extruder (11) receives organic filler, preferably wood particles or fiber, having a variable moisture content. Moisture is withdrawn from the extruder barrel. A polymer is fed from a second extruder (15) into the barrel of the first extruder (11) after the polymer is heated, mixed, and melted in the second extruder (15). The second extruder (15) can be a single screw or twin screw extruder. The combined mixture of organic filler and polymer is further mixed alone or with optional additives. The mixture is vacuum vented to remove moisture and volatiles and then extruded through a die. Additional processing steps are optional depending upon the extruded product or profile being produced.

### BACKGROUND OF THE INVENTION

1. Field of the Invention

This invention relates to two-extruder combination for processing wood fiber and process for same. More specifically, this invention relates to a counter-rotating twin screw extruder with a side injection extruder for processing wood and other fibers with polymer or similar material to make extruded profiles and process for same.

2. Description of Background Art

Various forms of equipment, including extrusion equipment, and methods have been developed in recent times to process organic fiber with polymer material. In particular, efforts have been made to process waste wood fiber with waste plastic to obtain usable, commercial products from “recycled materials.”

Typically, this equipment and the processes for operating this equipment on such materials have proven to be impractical because of the inconsistent characteristics of the wood fibers and plastics being processed. The variety and moisture content of source materials often cause poor quality control for the end product. The characteristics of the feed materials can be damaging to the equipment, particularly the extruder screws and barrels.

Extrusion processing of natural materials containing varying amounts of moisture presents numerous technical difficulties when venting moisture vapors from the barrel during operation of the extrusion equipment. The material can obstruct vent and/or vacuum passages and disrupt the process. Additionally, processing plastic wherein the material contains a mixture of polymers can create difficulties due to the different melting points of the various polymer materials. These processing difficulties lead to significant variations in the final product being produced.

The moisture content of wood fibers in most extrusion processes requires drying to less than one percent to obtain a maximum output rate. Dry wood fiber has the added disadvantage that it cannot be stored. Pre-drying an organic filler such as wood fiber requires additional feeding apparatus, high intensity mixers, preheaters, hot air dryers, and/or rotary furnaces. Moisture removal equipment and procedures are expensive because of their additional equipment purchase and operating costs as well as the additional time and labor required in processing. These procedures with wood fiber can also be a fire hazard.

The twin screw extruder systems currently used in the industry have numerous disadvantages. Counter-rotating twin screw extruders often require a drying system, a feed material size reduction system, and/or a blending system. Material transportation equipment used with twin screw extrusion equipment often renders it difficult to maintain a mix ratio of material or can require an additional pelletizing operation. The additional equipment required with known twin screw extrusion equipment requires additional floor space and higher operational costs for power, labor, and maintenance. Such systems are difficult to vent inherent moisture from the organic filler and, when the polymer is melted with the wood, have a significant risk of burning the organic filler.

The processing of undried wood with co-rotating twin screw extrusion equipment requires peripheral feeding systems. Co-rotating twin screw extrusion equipment has high screw speeds (RPM) and no screw cooling. This combination presents a greater risk of burning the material at the screw tips. Co-rotating twin screw extrusion equipment cannot maintain a low melt temperature with higher head pressures which can burn the fiber during melting with the polymer.

U.S. Pat. No. 4,915,764 to Miani discloses a method of making panels. The invention of this patent combines a mixture of organic filler and thermoplastic resin. The extrusion equipment disclosed in this patent is constructed for multiple stages of feeding thermoplastic resin charges into organic filler as it is processed. This equipment is also adapted for multiple stages of degassing.

U.S. Pat. No. 5,497,594 to Giuseppe et al. discloses an advanced polymer and wood fiber composite structural component. This patent discloses a desirable end product made from wood fiber and polymer composite which can be extruded or injection molded.

The industry is lacking efficient, reliable, and economical extrusion equipment and a method for processing wood fiber and polymer material into a useful product. In particular, the industry lacks extrusion equipment and a method for processing wood fiber with polymer wherein the wood fiber has varying and/or a high concentration of moisture.

### SUMMARY OF THE INVENTION

The invention includes extrusion equipment. The extrusion equipment includes a first extruder. The first extruder has a barrel. A feeding means for organic filler into the barrel of the first extruder is included. A moisture removing means removes moisture from the barrel of the first extruder and dries the organic filler. The invention includes at least one secondary extruder having a polymer mixing and heating means and feeding means for the mixed, heated, and melted polymer to feed the polymer into the barrel of the first extruder. A mixing and heating means for the organic filler with the polymer is included in the barrel of the first extruder with a vacuum venting means for moisture and volatile removal. A feeding means for the mixed organic filler and polymer from the barrel of the first extruder through a die is included.

The invention is also a process having two extruders are linked together. The first extruder is, desirably, a counter-rotating twin screw extruder. The first extruder receives organic filler, preferably wood particles, having a variable moisture content. Moisture is withdrawn from the fiber in the first stage of the first extruder's barrel. A melted polymer is injected from a second extruder into the barrel of the first extruder after the polymer is heated and mixed in the second extruder. The second extruder can be a single or twin screw extruder. The combined mixture of organic filler and polymer is further mixed, vented, and extruded through a die. Additional processing steps are optional depending upon the profile being produced.

### BRIEF DESCRIPTION OF THE DRAWINGS

FIG. 1 is a top plan view of the preferred embodiment of the extrusion equipment of the invention.

FIG. 2 is a side plan view of the preferred embodiment of the extrusion equipment of the invention.

FIG. 3 is a front plan view of the preferred embodiment of the extrusion equipment of the invention.

FIG. 4 is a side plan view of the barrel of the invention.

FIG. 5 is a top plan view of a large venting surface area of the extruder barrel with an air/moisture removal system.

FIG. 6 is a side view of an injection port adapter to receive hot polymer from the second extruder into the first extruder.

### DETAILED DESCRIPTION OF THE INVENTION

The invention includes extrusion equipment and a process wherein two extruders are linked together. The first extruder is, desirably, a counter-rotating twin screw extruder. The first extruder receives organic filler, preferably wood particles, that can have a variable moisture content. The moisture content of the organic filler can vary depending on the amount of atmospheric moisture absorbed by the filler before it is fed to the extruder. Moisture is withdrawn from the extruder barrel. A melted polymer is fed from a second extruder into the barrel of the first extruder after the polymer is heated and mixed in the second extruder. The second extruder can be a single screw or twin screw extruder. The combined mixture of organic filler and polymer is further mixed, vacuum vented, and extruded through a die. Additional processing steps are optional depending upon the “profile” or extruded article being produced.

The first extruder of the invention receives and processes organic filler, such as wood fiber. The extrusion equipment of the invention, and especially the preferred embodiment using a first extruder that is a counter-rotating twin screw extruder, is advantageous for processing wood fiber because of its ability to mix thoroughly and vent this material with a plastic or other polymer.

A counter-rotating twin screw extruder requires minimal considerations for wood selection, does not require moisture removal, and is suitable for blending and feeding composite materials. The use of a twin screw extruder for the first extruder of the invention is desirable for (1) heat-sensitive polymers, such as PVC, (2) low temperature extrusion, such as wood fiber or foam, (3) noncompounded materials, such as powder blends, (4) materials that require degassing, and/or (5) difficult feeding materials.

The extruder screw of the first extruder of the invention is, desirably, a multi-zone extruder screw. Preferably, the invention is a combination of a “right” extruder screw and a “left” extruder screw for use in combination as counter-rotating twin extruder screws. The extruder screw of this invention receives organic filler, mixes the particles of the organic filler, permits the removal of moisture from the organic filler, mixes the organic filler with molten polymer, and permits the removal of moisture and volatiles desirably by a vacuum vent. The flights of the screw cooperate with the extruder barrel to remove moisture without the loss of organic filler from the barrel.

Desirable embodiments of the invention include an extruder barrel with a large venting surface area subsequent to a feed port for the organic filler. This venting area is heated and has a large opening with a large upright vent stack. Air is drawn from the vent stack. The organic filler is dried by the removal of vapor.

The invention optionally includes an extruder barrel with a large venting surface area as described above and having a small grooved cap on the downstream side. The grooved cap is desirably manufactured at an angle to the extruder screw. The cap is grooved in a manner similar to grooved feed single screw extruders. The grooved cap forces organic filler back into the extruder barrel and screw if the organic filler “fluffs” over the screws in the venting area.

The invention desirably includes an extruder barrel with a large vent stack with at least one port for injecting air into the dried organic filler. The pressurized air fluidizes the dried organic filler. The fluidized organic filler allows consistent moisture removal from all the fiber particles.

Desirable embodiments of the invention include an extruder barrel with an injection port adapter to receive hot polymer from the second extruder. The injection port adapter is desirably on top of the barrel. Molten polymer from the second extruder is injected through the injection port adapter through the top of the barrel. The hot polymer enters the barrel at the apex between the counter-rotating twin screws in the preferred embodiment of the invention.

The invention desirably includes an extruder barrel with a vacuum vent zone. The top section of the barrel vent zone is desirably water-cooled to prevent the adherence of melted polymer that can block the vent holes. The geometry of the vacuum zone provides a gap above the screws. The gap allows any material that flows over the screw flights to be forced back down into the flights without blocking the vacuum vent holes. The vacuum section retains the mixed material in the flight of the screw.

The invention is also a process having two extruders linked together. The first extruder is, desirably, a counter-rotating twin screw extruder. The first extruder receives organic filler, preferably wood particles, having a variable moisture content. Moisture is withdrawn from the extruder barrel. A melted polymer is fed from a second extruder into the barrel of the first extruder after the polymer is heated and mixed in the second extruder. The second extruder can be a single screw or twin screw extruder. The combined mixture of organic filler and polymer is further mixed, vacuum vented, and extruded through a die. Additional processing steps are optional depending upon the profile being produced.

The extrusion equipment and process of the invention require few formulation considerations and are therefore desirable for processing recycled materials of varying grades and characteristics. Formulation considerations involve the selection of an organic filler, polymer, and optional additional components such as stabilizers, lubricants, coupling agents, pigments, and other the like. The price and availability of any one or more of these components are common factors in the selection of the various components.

The most common organic filler for use with the invention is wood fiber, but other organic fillers include lawn waste, agricultural waste such as pulverized corn stalks, and natural fibers from land or aqueous plants such as cotton. Suitable wood species include softwoods and/or hardwoods. The most popular wood fibers for profile formation are pine, maple, and oak.

The selection of wood fiber for use with the invention requires a wood fiber grade that provides the interstitial strength desired for the final product. It is important to note that wood dust is a strong to severe explosive hazard if a dust “cloud” contacts an ignition source.

The characteristics provided to the final profile by a wood fiber are determined in part by the mesh size as well as the surface and physical characteristics of the wood fiber. Desirable wood fibers have a moisture content from about four percent to seven percent by weight, but the invention can be used with wood fibers having significantly lesser or greater moisture contents. Desirable wood fiber bulk density is about 12 to 18 pounds per cubic foot. The color of a profile can vary by the ratio of heartwood to sapwood, the consistency of particle size, color, and density.

The selection of a polymer for use with the invention has few restrictions. Desirable polymers can be natural or synthetic polymers. Desirable synthetic polymers can be thermoset or thermoplastic polymers. The most desirable polymers include a member selected from a group consisting of polyvinylchloride (PVC), polypropylene (PP), polyethylene (PE), and polystyrene (PS).

The wood fiber is fed into the extrusion equipment of the invention. The preferred equipment for feeding fibrous material is to “cram” or force-feed into the first extruder of the invention. Cramming or force-feeding utilizes an auger to force the material into the feed zone of the extruder screws. This system will increase the efficiency of the feed zone. Cramming or force-feeding is necessary for low-bulk density organic filler such as wood fiber.

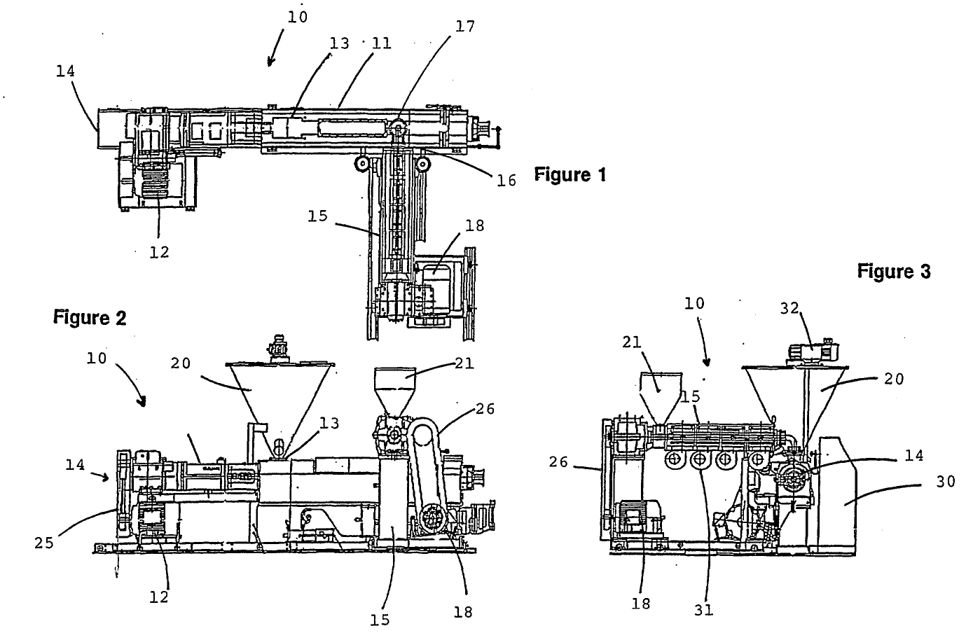

FIGS. 1, 2, and 3 illustrate the preferred embodiment of the extrusion equipment of this invention. The invention includes at least two extruders linked together.

FIG. 1 is a top plan view of the preferred embodiment of the extrusion equipment 10 of the invention. A first extruder 11 is a counter-rotating twin screw extruder. The first extruder 11 operates by motor 12 and has organic filler feed port 13. A die 14 is at the exit of the first extruder 11. The die 14 is selected to provide the geometric shape desired for the profile or preform article made by the invention. A second extruder 15 has an exit 16 linked to the injection port 17 of the first extruder 11. The second extruder 15 operates by second motor 18.

FIG. 2 is a side plan view of the preferred embodiment of the extrusion equipment 10 of the invention. An organic filler feed hopper 20 is mounted at the organic filler feed port 13 to the first extruder 11. The second extruder 15 is fed raw polymer through polymer hopper 21. A variety of alternative feed systems can be substituted for the organic feed hopper 20 and polymer hopper 21 such as a conveyer system, screw feeder, or other commercially available equipment. A first belt drive linkage 25 to motor 12 operates the screws (not shown) of the first extruder 11. A second belt drive linkage 26 to second motor 18 operates the screw (not shown) of the second extruder 15. Alternative belt and non-belt drive linkages or direct drive systems can be used with the invention.

FIG. 3 is a front plan view of the preferred embodiment of the extrusion equipment 10 of this invention. The second extruder 15 is illustrated with the polymer hopper 21 and one or more heaters 31. The first extruder 11 is illustrated with the organic filler feed hopper 20 having a motorized mixer 32. A control panel 30 controls the operation of the extrusion equipment 10.

The first extruder 11 is, desirably, a counter-rotating twin screw extruder. The first extruder receives organic filler having a variable moisture content. Moisture is withdrawn from the extruder barrel. A melted polymer is fed from a second extruder 15 into the barrel of the first extruder 11 after the polymer is heated and mixed in the second extruder 15. The second extruder 15 can be a single screw or twin screw extruder. The combined mixture of organic filler and polymer is further mixed, vacuum vented, and extruded through the die 14.

The preferred embodiment of the invention uses a left-hand screw and a right-hand screw as counter-rotating twin screws. The multi-zone extruder screw, preferably, has a large feed and vent zone for its initial processing of organic filler. The extruder screws of this invention receive organic filler, mix the particles of the organic filler, permit the removal of moisture from the organic filler, mix the organic filler with molten polymer, and vacuum vent the composite material. The flights of the screw cooperate with the extruder barrel to remove moisture without the loss of organic filler from the barrel.

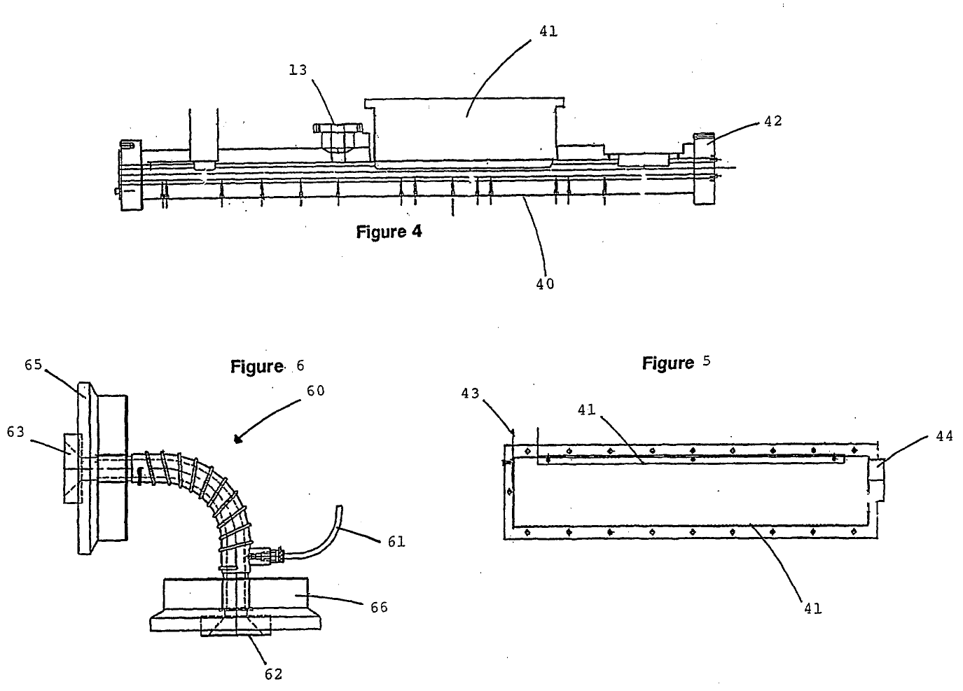

FIG. 4 illustrates an extruder barrel 40 for use with the invention. The extruder barrel 40 has a large venting surface area 41 subsequent to the organic filler feed port 13 for the organic filler. This venting surface area 41 is heated and desirably has a large opening with an air/moisture removal system. Air and moisture are drawn from the large opening. The organic filler is dried by the removal of vapor. A mounting plate 42 is provide for a die 14.

FIG. 5 illustrates a top plan view of a large venting surface area 41 of the preferred extruder barrel 40. The venting surface area 41 is the internal portion of a venting hood. with a vent port 43 and a vent stack 44 connected to an air removal system (not shown). The large venting surface area 41 is, desirably, subsequent to the feed port 13 for the organic filler. The venting surface area 41 has a large opening at the vent stack 44 which is connected to the air removal system. Air and vapor are drawn from the large opening. The organic filler is dried by the removal of vapor.

The invention, optionally, includes an extruder barrel with a large venting surface area as described above having a grooved cap (not shown). The grooved cap is desirably manufactured at an angle to the extruder screw. The cap is grooved in a manner similar to grooved feed single screw extruders. The grooved cap forces organic filler back into the extruder barrel and screws if the organic filler fluffs over the screws in the venting area.

FIG. 6 illustrates a desirable injection port adapter 60 to receive hot polymer from the second extruder 15 into the first extruder 11. The injection port adapter 60 is, desirably, on top of the barrel 40. Molten polymer from the second extruder 15 is injected through the injection port adapter 60 through the top of the barrel 40. The hot polymer enters the barrel 40 at the apex between the counter-rotating twin screws. The injection port 60 of this embodiment includes a thermocouple 61, two spacer rings 62 and 63, an inlet adapter 65, and an outlet adapter 66.

Preferred embodiments of the invention have an extruder barrel with a vacuum vent zone. The top section of the barrel is desirably water-cooled to prevent the adherence of melted polymer. The geometry of the vacuum zone provides a gap above the screw. The gap allows any material that flows over the screw flights to be forced back down into the flights without blocking the vacuum vent holes. The vacuum section retains the mixed material in the flight of the screw.

The invention includes an extrusion process. The process includes feeding organic filler into a barrel of a first extruder. Removing moisture from the barrel of the first extruder is performed to dry the organic filler. Mixing and heating polymer in at least one secondary extruder occur. Then, feeding the mixed, heated polymer into the barrel of the first extruder is performed. Mixing and heating the organic filler with the polymer in the barrel of the first extruder occur. Vacuum venting to remove moisture and volatiles is performed such that the organic filler, polymer, or a mixture thereof is retained in the extrusion equipment for use in the process. Feeding the mixed organic filler and polymer from the barrel of the first extruder through a die is performed.

The extrusion equipment and process of the invention have the following advantages. The invention processes wood fiber with higher moisture content than traditional equipment and processes. The invention uses lower screw speeds or “RPM” and lower shear than traditional equipment and processes. The invention uses a separate melting process of polymer from the organic fiber and provides good mixing of wood fiber and polymer. The melted polymer encapsulates fibers more easily and consistently. The extrusion equipment uses standard screw cooling and eliminates the risk of burning at screw tips.

The invention is also able to maintain low melt temperatures with high head pressures. The extrusion equipment provides a superior venting system, prevents material from sticking and clogging vent ports, and prepares the composite melt before it reaches the vent port. The cost of drying, material size reduction, and preblending operations are eliminated. The invention resolves the material transportation/mix ratio difficulties of traditional equipment and processes. The invention is flexible and permits the switching of composite ratios “on the fly.” The invention permits processing of a complete range of polymers without major equipment changes.

What is claimed is:

1. Extrusion equipment comprising:
a first extruder, said first extruder has a barrel;
a means for feeding organic filler into said barrel of said first extruder;
a means for removing moisture from said barrel of said first extruder, said means for removing moisture dries said organic filler;
at least one secondary extruder, said secondary extruder has means for mixing and heating polymer and means for feeding said mixed, heated, and melted polymer into said barrel of said first extruder; and
means for mixing and heating said organic filler with said polymer in said barrel of said first extruder, means for vacuum venting of moisture and volatile removal, and means for feeding said mixed organic filler and polymer from said barrel of said first extruder through a die.

2. The extrusion equipment of claim 1, wherein said first extruder is a counter-rotating twin screw extruder.

3. The extrusion equipment of claim 1, wherein said second extruder can be a single screw or twin screw extruder.

4. The extrusion equipment of claim 2, wherein said means for mixing and heating said organic filler with said polymer in said barrel of said first extruder and means for feeding said mixed organic filler and polymer from said barrel of said first extruder comprise a multi-zone extruder screw.

5. The extrusion equipment of claim 4, wherein said multi-zone extruder screw is a combination of a right extruder screw and a left extruder screw in counter-rotation.

6. The extrusion equipment of claim 5, wherein said counter-rotating twin screws are configured with a large initial feed and vent zone.

7. The extrusion equipment of claim 2, wherein said extruder barrel of said first extruder has a large venting surface area subsequent to a feed port for said organic filler.

8. The extrusion equipment of claim 7, wherein said large venting surface area has a large opening, said large opening is connected to an air/moisture removal system.

9. The extrusion equipment of claim 8, wherein said large venting surface area has a grooved cap, said grooved cap is at an angle to said extruder screw and forces said organic filler back into the extruder barrel and screws from said venting area.

10. The extrusion equipment of claim 2, wherein said extruder barrel vent stack has at least one port for injecting air into said dried organic filler, said pressurized air fluidizes said dried organic filler for consistent and even moisture removal from all the fiber particles.

11. The extrusion equipment of claim 2, wherein said barrel of said first extruder has an injection port adapter to receive hot polymer from said second extruder, said injection port adapter is mounted on top of said barrel whereby said heated polymer from said second extruder is injected through said injection port adapter through said top of said barrel at an apex between said counter-rotating twin screws.

12. The extrusion equipment of claim 6, wherein said extruder barrel of said first extruder has a means for water-cooling a top section of said barrel in the vacuum zone, said vacuum zone barrel top section has a gap above said screw which allows material to flow over the screw flights and be forced back down into the screw channel.

13. An extrusion process comprising:
feeding organic filler into a barrel of a first extruder;
removing moisture from said barrel of said first extruder to dry said organic filler;
mixing and heating polymer in at least one secondary extruder;
feeding said mixed, heated polymer into said barrel of said first extruder, mixing and heating said organic filler with said polymer in said barrel of said first extruder;
vacuum venting to remove moisture and volatiles; and
feeding said mixed organic filler and polymer from said barrel of said first extruder through a die.

14. The extrusion process of claim 13, wherein said organic filler comprises wood fiber and other fibers.

15. The extrusion process of claim 13, wherein said polymer includes a member selected from a group consisting of polyvinylchloride, polypropylene, polyethylene, polystyrene, and other thermoplastic and thermoset materials.
